(19) United States
(12) Patent Application Publication
(10) Pub. No.: US 2026/0236545 A1
(43) Pub. Date: Aug. 13, 2026

(54) INFORMATION PROCESSING APPARATUS, METHOD, AND STORAGE MEDIUM

(71) Applicant: CANON KABUSHIKI KAISHA, Tokyo (JP)

(72) Inventor: KENICHI HIROSE, Kanagawa (JP)

(21) Appl. No.: 19/531,223

(22) Filed: Feb. 5, 2026

(30) Foreign Application Priority Data
Feb. 13, 2025 (JP) 2025-021453

(51) Int. Cl. G06F 16/9535; G06F 16/35

(52) U.S. Cl. CPC G06F 16/9535; G06F 16/35

(57) ABSTRACT

A method for controlling an information processing apparatus includes classifying a plurality of pieces of content corresponding to a result of a search processing into a plurality of elements each corresponding to a category of a plurality of categories based on information included in a plurality of Uniform Resource Locators (URLs), receiving a selection of at least one element from the plurality of elements, and displaying at least one piece of content corresponding to a second word, the second word being at least one word corresponding to the at least one of the selected elements from among the plurality of pieces of content.

### BACKGROUND

### Field of the Technology

The present disclosure relates to an information processing apparatus, a method, and a storage medium.

### Description of the Related Art

In a technique for searching a web site, a user inputs a search word and transmits the search word to a search service server, which performs an internal site search and displays a search result list including at least links and titles of a plurality of pieces of content on the target web site. To enable the user to reach the target content from the search result list, the user searches for the target content based on information such as the title and description of the content included in the search result list. Alternatively, if the search result list does not include the target content, the user generally inputs a different search word and performs the search again.

Japanese Patent No. 4359787 describes a technique for acquiring content ranked high in a search result obtained by an internal site search on a web site, extracting keywords from the acquired content, and displaying the reputation of the web site based on the number of keywords included in the web site.

In an internal site search on a web site including a plurality of pieces of content of a plurality of products, when the user performs an internal site search by inputting search words for functions of a plurality of products, the plurality of pieces of content of the plurality of products on the web site are listed as a search result. In this case, if the target content that the user wants to view is not listed at the top of the search results, the user needs to browse through a plurality of pieces of content listed in the search result to find the target content.

Alternatively, to display the target content at the top of the search results, the user needs to input an additional search word and perform the internal site search again. Thus, it takes considerable effort and time for the user to reach the target content from the search results.

### SUMMARY

The present disclosure is directed to enabling identification of an additional search word for re-searching to narrow down the search results.

According to an aspect of the present disclosure, a method for controlling an information processing apparatus includes receiving an input of a first word as a word to be used in a search, performing, using the first word, search processing for searching for content in a web site provided by a predetermined server, acquiring a result of the search processing, classifying a plurality of pieces of content corresponding to the result of the search processing into a plurality of categories based on information included in a plurality of Uniform Resource Locators (URLs) included in the result of the search processing, classifying the plurality of pieces of content corresponding to the result of the search processing into a plurality of elements each corresponding to a category of the plurality of categories based on the information included in the plurality of URLs, receiving a selection of at least one element from the plurality of elements, displaying at least one piece of content corresponding to a second word as at least one word corresponding to the at least one of the selected elements from among the plurality of pieces of content, and performing search processing for searching for content in the web site by using the first word and the second word as at least one word corresponding to the at least one of the selected elements.

Features of the present disclosure will become apparent from the following description of embodiments with reference to the attached drawings. The following description of embodiments is described by way of example.

### BRIEF DESCRIPTION OF THE DRAWINGS

FIG. 1 is a hardware configuration diagram.

FIGS. 2A, 2B, and 2C are diagrams illustrating search screens.

FIG. 3 illustrates a search processing sequence diagram.

FIG. 4 is a flowchart illustrating Uniform Resource Locator (URL) analysis on a search result.

FIG. 5 illustrates a URL format character string list.

FIG. 6 illustrates a URL analysis character string list.

FIG. 7 illustrates a hierarchical database (DB).

FIG. 8 is a flowchart illustrating generation of an additional search word list.

FIG. 9 illustrates an additional search word list.

FIG. 10 illustrates a search processing sequence diagram.

### DESCRIPTION OF THE EMBODIMENTS

Hereinafter, embodiments of the present disclosure will be described in detail with reference to the drawings. The following embodiments are not intended to limit the present disclosure as defined by the claims, and not all combinations of features described in these embodiments are necessarily essential to the solutions of the present disclosure.

### First Embodiment

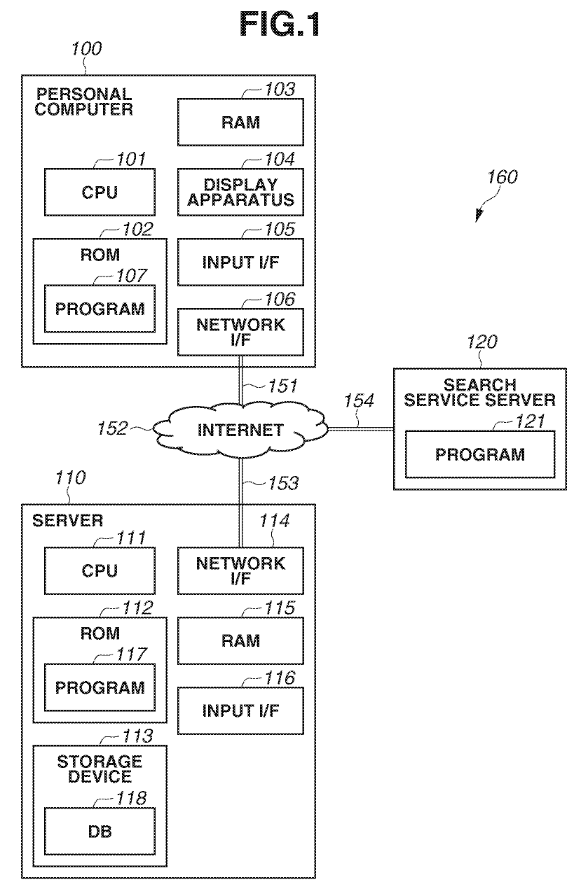

FIG. 1 is a diagram illustrating an example of a hardware configuration of a search result display system 160 according to a first embodiment. The search result display system 160 includes a personal computer (PC) 100, a server 110, and a search service server 120.

The PC 100 includes a central processing unit (CPU) 101, a read only memory (ROM) 102, a random access memory (RAM) 103, a display apparatus 104, an input interface (I/F) 105, and a network I/F 106. The ROM 102 stores programs 107 such as a browser. The PC 100 can connect to the Internet 152 via a network connection 151 with an Ethernet cable or Wireless Fidelity (Wi-Fi®).

The PC 100 is an example of an information processing apparatus. Examples of applicable information processing apparatuses include a personal computer (PC), a smartphone, a tablet terminal, and a personal digital assistant (PDA).

The server 110 is a web server for providing a web site. The server 110 includes a CPU 111, a ROM 112, a storage device 113, a network I/F 114, a RAM 115, and an input I/F 116. The ROM 112 stores a program 117 for executing search processing and search result display processing. The program 117 maintains a Uniform Resource Locator (URL) format list and a URL analysis character string list. The storage device 113 stores a hierarchical database (DB) 118. The server 110 can connect to the Internet 152 via a network connection 153.

The PC 100 and the server 110 can communicate with each other via the Internet 152.

The search service server 120 for providing search services includes a program 121 that is a search engine. Examples of search engines include GoogleTM web search and Microsoft ® BingTM search engine. The search service server 120 can connect to the Internet 152 via a network connection 154.

A web site provided by the server 110 will now be described. The user accesses a web site from the PC 100 via the Internet 152 and displays the web site on the browser of the PC 100. The web site is, for example, one that provides printer product manuals and internal site search functions. The user inputs a search word from a search screen displayed on the web site and searches for the content of a product manual.

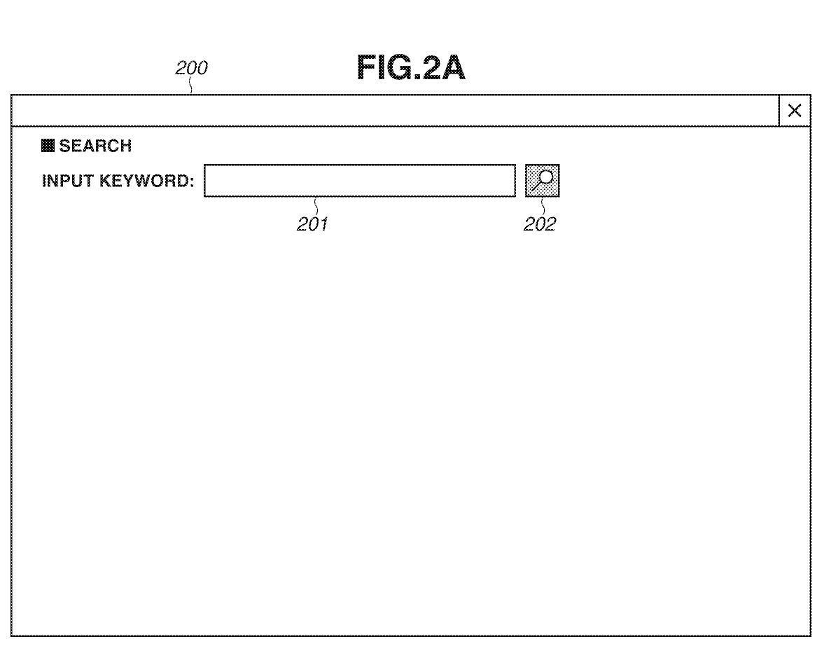

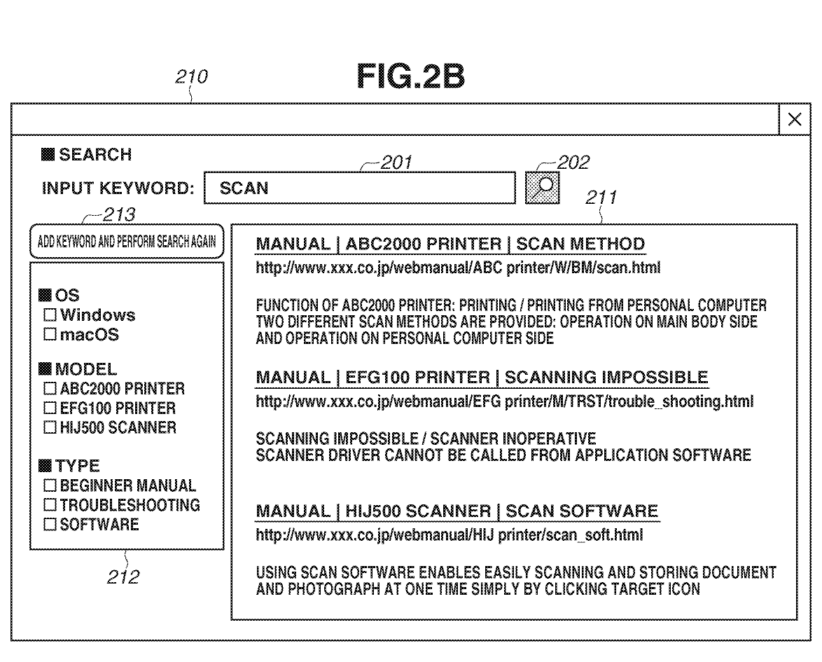

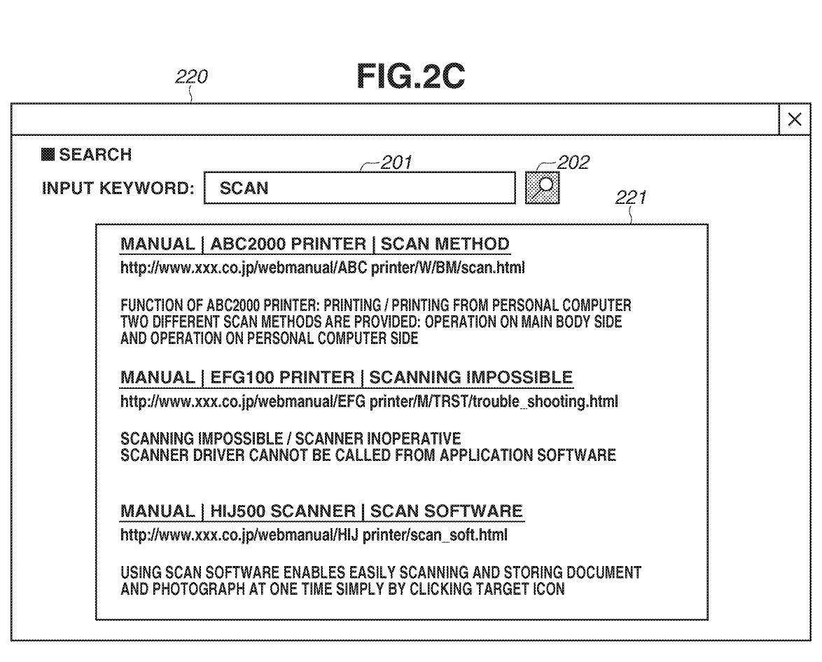

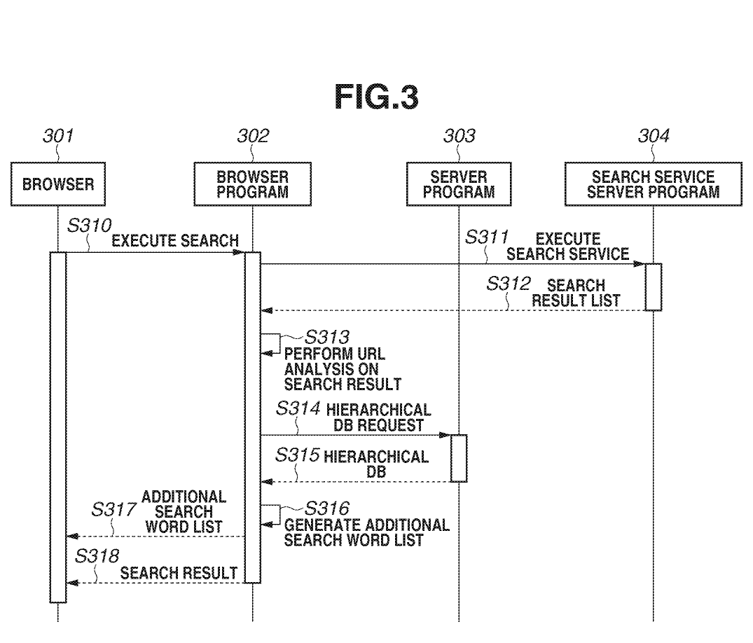

In the present embodiment, the processing in which the user performs an internal site search to find content on the web site and displays the search result and an additional search word list will be described. The present embodiment will be described in detail below with reference to FIGS. 2A, 2B, and 3.

FIGS. 2A to 2C illustrate examples of a browser screen displayed on the display apparatus 104 of the PC 100.

FIG. 2A illustrates a search start screen 200 of the browser displayed on the display apparatus 104 of the PC 100. The search start screen 200 includes a search word input field 201 and a search button 202. When the user inputs a search word in the search word input field 201 and then presses the search button 202 on the search start screen 200, the browser displays a search result screen 210 as illustrated in FIG. 2B on the display apparatus 104 of the PC 100. The search result screen 210 includes the search word input field 201, the search button 202, a search result 211, an additional search word list 212, and a re-search button 213 for adding a search word enumerated in the additional search word list 212 and performing a search again.

FIG. 3 is a search processing sequence diagram illustrating processing for performing search processing on the search start screen 200 displayed on a browser 301 and displaying the search result screen 210 on the browser 301.

A browser program 302 illustrated in FIG. 3 is downloaded into the RAM 103 of the PC 100 and operates on the browser 301. A server program 303 illustrated in FIG. 3 is the program 117 operating on the server 110. A search service server program 304 illustrated in FIG. 3 is the program 121 of the search engine operating on the search service server 120. The operations in steps S310 to S318 will be described below.

In step S310, when the user inputs a search word in the search word input field 201 and then presses the search button 202 on the search start screen 200 displayed on the browser 301, the browser 301 issues a search processing execution instruction to the browser program 302.

In step S311, the browser program 302 issues a search service processing execution instruction to the search service server program 304.

In step S312, the browser program 302 acquires a search result list returned from the search service server program 304. Items included in the search result list include information such as the URL, title, and description of the content.

In step S313, the browser program 302, having acquired the search result list, performs URL analysis on the search result list.

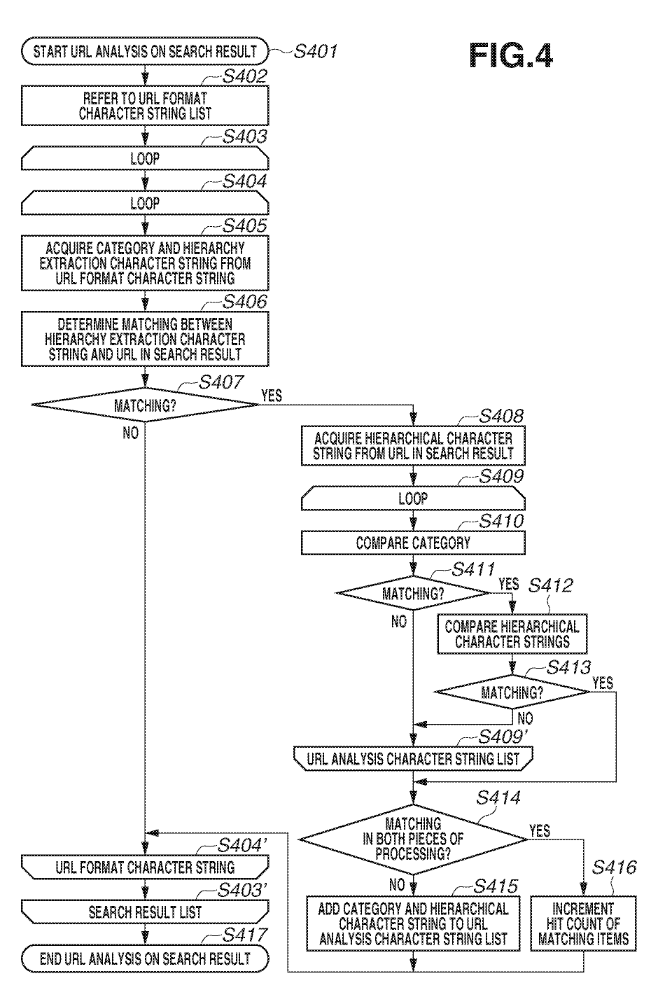

Processing of the URL analysis (S313) on the search result list will be described in detail below with reference to FIG. 4.

FIG. 4 is a flowchart illustrating processing from when the browser program 302 starts URL analysis on the search result list (step S313) in step S401 until the program completes the URL analysis. The operations in steps S402 to S417 will be described below.

In step S402, the browser program 302 refers to a URL format character string list maintained by the browser program 302.

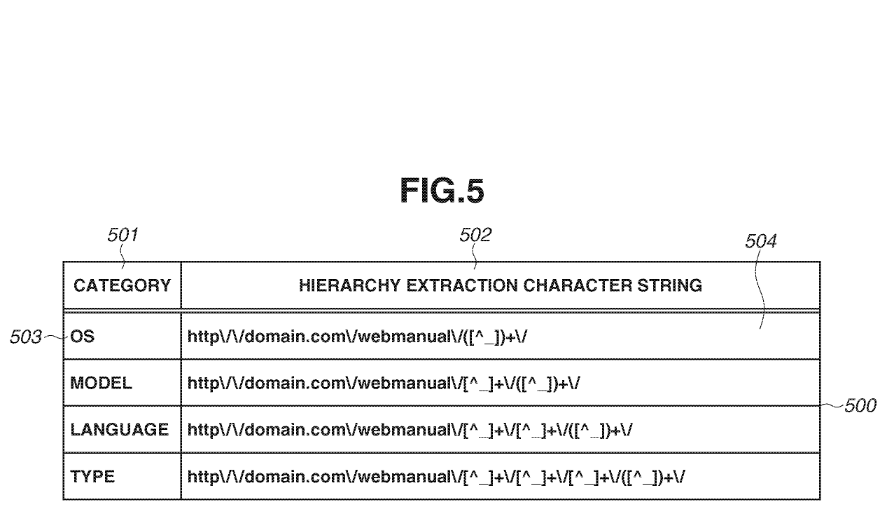

As an example of the URL format character string list maintained by the browser program 302, a URL format character string list 500 in FIG. 5 will be described below. The URL format character string list 500 includes a category field 501 indicating the type of the character string for each hierarchy of the URL, and a hierarchy extraction character string field 502 for extracting a hierarchical character string of the URL using regular expressions.

Returning to FIG. 4, in between step S403 and S403’, the browser program 302 sequentially repeats the following processing the number of times corresponding to the number of URLs of the pieces of content included in the search result list acquired in step S312. When the following processing has been completed for all URLs of the pieces of content included in the search result list acquired in step S312, the browser program 302 exits from the loop processing between step S403 and S403’.

In between step S404 and S404’, the browser program 302 sequentially repeats the following processing the number of times corresponding to the number of items included in the URL format character string list 500. When the following processing has been completed for all items included in the URL format character string list 500, the browser program 302 exits from the loop processing between step S404 and S404’.

In step S405, the browser program 302 acquires an entry in the category field 501 and an entry of the hierarchy extraction character string field 502 from the URL format character string list 500.

In step S406, the browser program 302 determines whether an entry in the hierarchy extraction character string field 502 matches a search result URL included in the search result list.

The processing in step S406 will be described in detail below. For example, the browser program 302 acquires the first item of the URL format character string list 500 illustrated in FIG. 5. In this case, the browser program 302 acquires "OS" as a category 503 and "http:\/\/domain.com\/webmanual\/([^_])+\/" as a hierarchy extraction character string 504. The hierarchy extraction character string 504 is a regular expression character string for acquiring the character string of the third hierarchy of the URL starting with "http://domain.com/webmanual/". Assume an example case where the search result URL is "http://domain.com/webmanual/W/".

In this case, the character string of up to the second hierarchy in the search result URL matches, and a character string exists in the third hierarchy in the search result URL. The browser program 302 determines that the URL matches the hierarchy extraction character string 504 through a matching process using regular expressions. If the search result URL is "http://domain.com/webpage/W/", the character string of the second hierarchy in the search result URL does not match the character string of the second hierarchy of the hierarchy extraction character string 504. In this case, the browser program 302 determines that the search result URL does not match the hierarchy extraction character string 504 through a matching process using regular expressions.

In step S407, if the browser program 302 determines that the result of the processing in step S406 does not indicate a match (NO in step S407), the processing returns to step S404. If the browser program 302 determines that the result of the processing in step S406 indicates a match (YES in step S407), the processing proceeds to step S408.

In step S408, the browser program 302 acquires a hierarchical character string from the search result URL by using the hierarchy extraction character string field 502.

The processing in step S408 will be described in detail below. For example, if the hierarchy extraction character string 504 acquired in step S405 is "http:\/\/domain.com\/webmanual\/([^_])+\/". If the search result URL is "http://domain.com/webmanual/W/", the hierarchical character string "W" is extracted from the search result URL through the extraction processing using regular expressions. If the search result URL is "http://domain.com/webmanual/M/", the hierarchical character string "M" is extracted from the search result URL through the extraction processing using regular expressions.

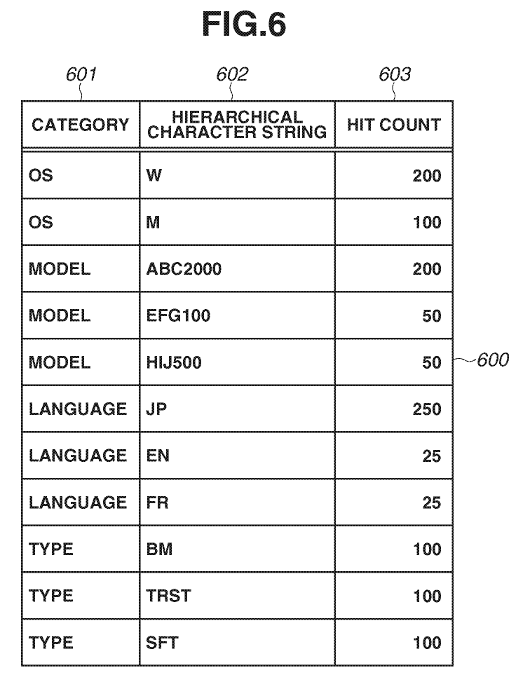

A URL analysis character string list 600 illustrated in FIG. 6 will be described below as an example of the URL analysis character string list maintained by the browser program 302. The URL analysis character string list 600 includes a category field 601, a hierarchical character string field 602, and a hit count field 603.

Returning to FIG. 4, after the processing in step S408, in between step S409 and S409’, the browser program 302 sequentially repeats the following processing the number of times corresponding to the number of items included in the URL analysis character string list 600 maintained by the browser program 302. When the following processing has been completed for all items included in the URL analysis character string list 600, the browser program 302 exits from the loop processing between step S409 and S409’.

In step S410, the browser program 302 compares an entry in the category field 501 acquired from the URL format character string list 500 in step S405 with an entry in the category field 601 of the URL analysis character string list 600.

In step S411, if the browser program 302 determines that the result of the comparison processing in step S410 indicates no match (NO in step S411), the processing returns to step S409. In step S411, if the browser program 302 determines that the result of the comparison processing in step S410 indicates a match (YES in step S411), the processing proceeds to step S412.

In step S412, the browser program 302 compares the hierarchical character string acquired in step S408 with an entry in the hierarchical character string field 602 in the URL in the analysis character string list 600.

In step S413, if the browser program 302 determines that the result of the comparison processing in step S412 indicates no match (NO in step S413), the processing returns to step S409. If the browser program 302 determines that the result of the comparison processing in step S412 indicates a match (YES in step S413), the loop processing in step S409 is ended and then the processing proceeds to step S414.

In step S414, the browser program 302 determines whether the results of both the comparison processing in step S411 and the comparison processing in step S413 indicate a match. If it is determined in step S414 that either result does not indicate a match (NO in step S414), the processing proceeds to step S415.

In step S415, the browser program 302 adds the entry in the category field 601 acquired in step S405 and the entry in the hierarchical character string field 602 acquired in step S408 to the URL analysis character string list 600, and then adds one in the corresponding hit count field 603.

In step S414, if the browser program 302 determines that both results indicate a match (YES in step S414), the processing proceeds to step S416.

In step S416, the browser program 302 increments the value in the hit count field 603 of the matching items in the URL analysis character string list 600.

When the loop processing of the search result list is completed, the processing proceeds to step S417 and ends the URL analysis on the search result (S313). In response to completion of the processing in step S313, the processing proceeds to step S314.

Returning to FIG. 3, in step S314, the browser program 302 issues a hierarchical DB request to the server program 303.

In step S315, the browser program 302 acquires the hierarchical DB from the server program 303.

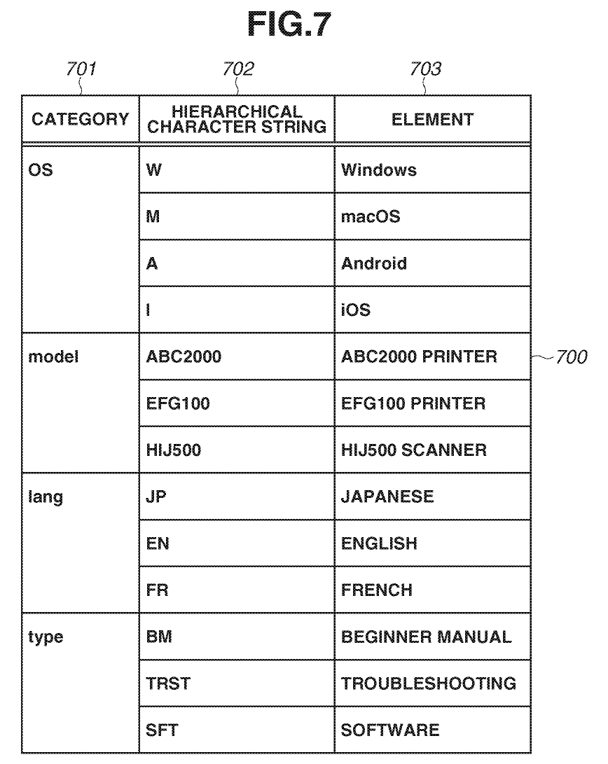

A hierarchical DB 700 illustrated in FIG. 7 will be described below as an example of the hierarchical DB maintained by the server program 303. The hierarchical DB 700 includes a category field 701, a hierarchical character string field 702, and an element field 703.

Returning to FIG. 3, in step S316, the browser program 302 generates an additional search word list by using the hierarchical DB 700 acquired in step S315.

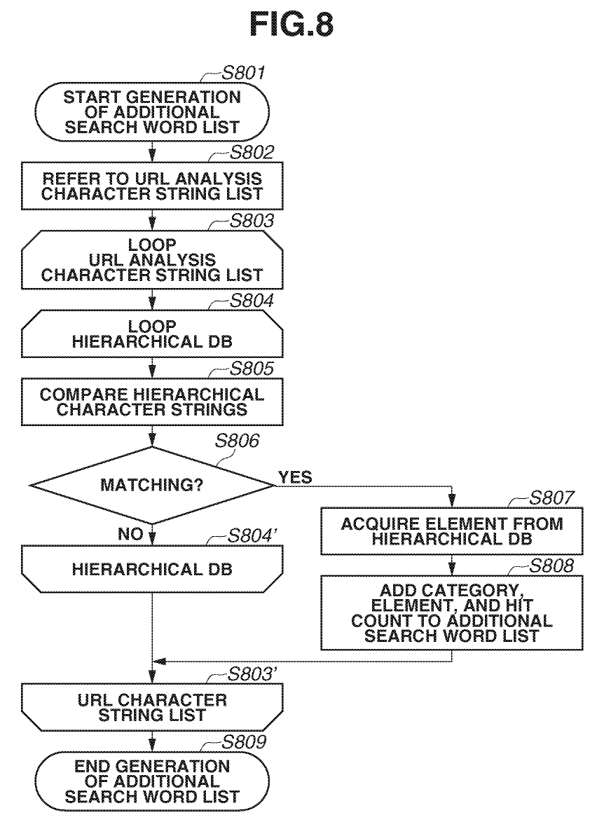

The processing in step S316 will be described in detail below with reference to FIG. 8. FIG. 8 is a flowchart illustrating the processing from when the browser program 302 starts the generation of the additional search word list (S316) in step S801 to when the program completes the generation. The operations in steps S802 to S809 will be described below.

In step S802, the browser program 302 refers to the URL analysis character string list 600.

In between step S803 and step S803’, the browser program 302 sequentially repeats the subsequent processing the number of times corresponding to the number of items included in the URL analysis character string list 600 acquired in step S802. When the subsequent processing has been completed for all items included in the URL analysis character string list 600, the browser program 302 exits from the loop processing between step S803 and S803’.

In between step S804 and step S804’, the browser program 302 sequentially repeats the subsequent processing the number of times corresponding to the number of items included in the hierarchical DB 700 acquired in step S315. When the subsequent processing has been completed for all items included in the hierarchical DB 700 acquired in step S315, the browser program 302 exits from the loop processing between step S804 and S804’.

In step S805, the browser program 302 compares an entry of the hierarchical character string field 602 of the URL analysis character string list 600 with an entry of the hierarchical character string field 702 of the hierarchical DB 700.

In step S806, the browser program 302 determines whether an item of the URL analysis character string list 600 matches an item in the hierarchical DB 700.

Processing in step S806 will be described in detail below. The browser program 302 compares an entry of the category field 601 of the URL analysis character string list 600 with an entry of the category field 701 of the hierarchical DB 700. If they match, the browser program 302 compares the corresponding entry of the hierarchical character string field 602 of the URL analysis character string list 600 with the corresponding entry of the hierarchical character string field 702 of the hierarchical DB 700. If both the category and the hierarchical character string match, the browser program 302 determines that the item of the hierarchical DB 700 is a matching item.

If the browser program 302 determines that the result of the comparison processing in step S805 indicates no match (NO in step S806), the processing returns to step S804. If the browser program 302 determines that the result of the comparison processing in step S805 indicates a match (YES in step S806), the processing exits the loop processing in step S804 and then proceeds to step S807.

In step S807, the browser program 302 acquires an entry of the element field 703 from the matching item of the hierarchical DB 700.

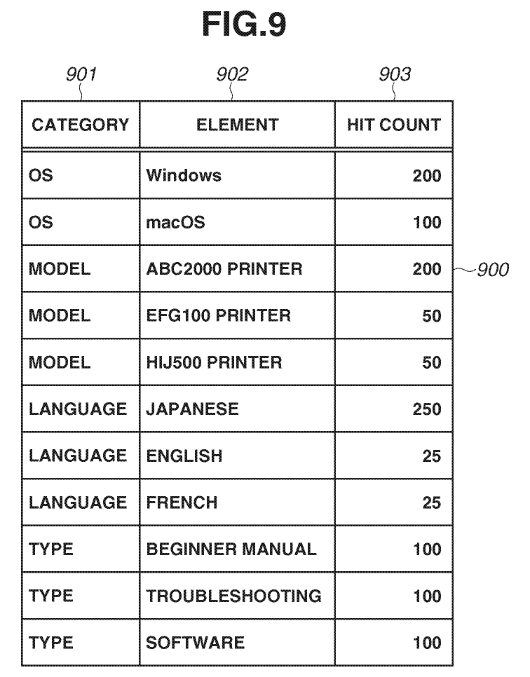

The additional search word list 900 illustrated in FIG. 9 will be described below as an example of an additional search word list maintained by the server program 303. The additional search word list 900 includes a category field 901, an element field 902, and a hit count field 903.

Returning to FIG. 8, in step S808, the browser program 302 adds the entry of the category field 601 of the URL analysis character string list 600, the entry of the element field 703 acquired from the hierarchical DB 700, and the entry of the hit count field 603 of the URL analysis character string list 600 to the additional search word list 900.

If the loop processing for the URL analysis character string list field 600 is completed, then in step S809, the browser program 302 ends the generation of the additional search word list (S316).

Returning to FIG. 3, in response to completion of the processing in step S316, in step S317, the browser program 302 returns the additional search word list 900 to the browser 301.

In step S318, the browser program 302 returns the search result to the browser 301.

The browser 301 displays the search result 211, the additional search word list 212, and the re-search button 213 on the search result screen 210. The additional search word list 212 lists the entries in the element field 902 by classifying the additional search word list 900 according to each entry of the category field 901.

As described above, the PC 100 is an example of an information processing apparatus. The browser program 302 operating on the browser 301 of the PC 100 is a program executed by the computer of the PC 100.

In step S312 in FIG. 3, the browser program 302 acquires the search result 211 of the content in a web site from the search service server 120 according to a search instruction on the browser 301.

In step S315 in FIG. 3, the browser program 302 acquires the hierarchical DB 700 from the server 110.

In step S316 in FIG. 3, referring to the hierarchical DB 700, the browser program 302 generates the additional search word list 212 based on the search result 211. More specifically, the browser program 302 generates an entry of the element (additional search word) field 703 corresponding to the entry of the hierarchical character string field 702 in the search result URL 211 as an entry of the element (additional search word) field 902 in FIG. 9.

The generation processing in step S316 may also be executed by the server program 303.

In steps S317 and S318 in FIG. 3, the browser program 302 provides the browser 301 with the search result 211 and the additional search word list 212 based on the search result 211 to be displayed on the browser 301, as illustrated in FIG. 2B. The browser program 302 arranges the entries of the element (additional search word) field 902 corresponding to the entries of the hierarchical character string field 602 in order of the entries of the hit count field 903 corresponding to the entries of the hierarchical character string field 602, as illustrated in FIG. 9.

More specifically, the browser program 302 provides an entry of the element (additional search word) field 902 for each category 901 as the additional search word list 212. The browser program 302 arranges the entries of the element (additional search word) field 902 for each entry of the category field 901 in descending order of the entries of the hit count field 903 corresponding to the entries of the hierarchical character string field 602. As illustrated in FIG. 5, the category field 501 corresponds to the hierarchy extraction character string field 502 in the search result URL 211.

As illustrated in FIG. 2B, an element of the element (additional search word) field 902 of the additional search word list 212 indicates the additional search word re-searchable by using the re-search button 213 on the browser 301.

According to the present embodiment, the additional search word list 212 for re-search is displayed together with the search result 211, thus providing the effect of enabling the user to identify search words for re-search to narrow down the search result 211. In addition, the method of analyzing the URL included in the search result 211 with the browser program 302 requires a shorter processing time than that in the method of analyzing the content of the search result or the method of acquiring content information from the DB via server communication. This provides the effect of reducing the time required to display the additional search word list 212. Analyzing the URL included in the search result 211 with the browser program 302 shortens the processing time required to display the additional search word list 212 and provides the effect of reducing the server processing load.

### Second Embodiment

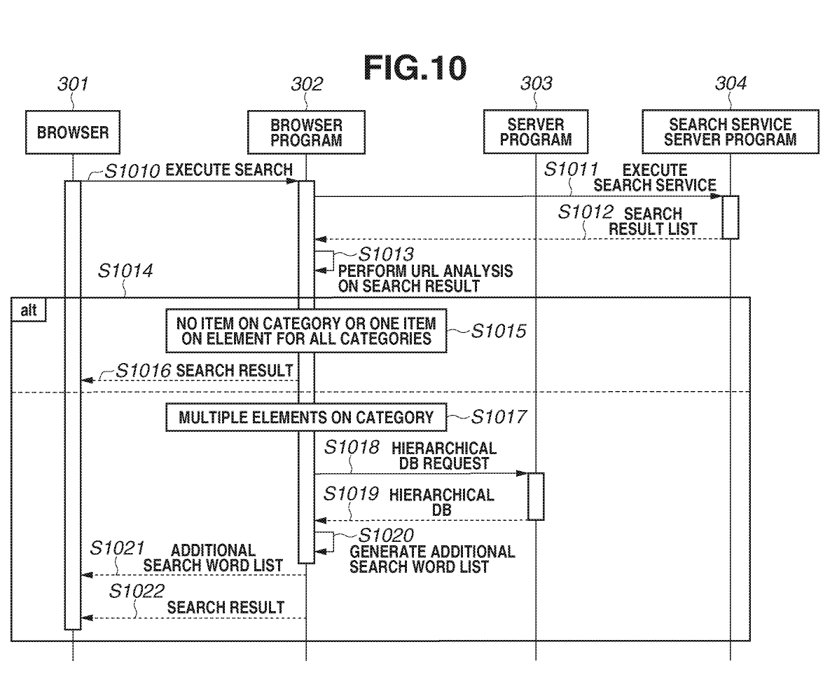

In a second embodiment, a case will be described in which the user switches between the display of the search result 211 and the display of the additional search word list 212 when performing an internal site search to find content in a web site. The second embodiment will be described in detail below with reference to FIG. 10.

FIG. 10 is a sequence diagram illustrating a process for executing search processing on the search start screen 200 displayed on the browser 301, and displaying the search result screen 210 on the browser 301. The browser program 302 illustrated in FIG. 3 is downloaded into the RAM 103 of the PC 100 and runs on the browser 301. Operations in steps S1010 to S1022 will be described below.

In step S1010, in response to the user inputting a search word in the search word input field 201 and then pressing the search button 202 on the search start screen 200 displayed on the browser 301, the browser 301 issues a search processing execution instruction to the browser program 302.

In step S1011, the browser program 302 issues a search service processing execution instruction to the search service server program 304.

In step S1012, the browser program 302 acquires the search result list returned by the search service server program 304. Each item included in the search result list contains information such as a URL of the content, a title of the content, and a description of the content.

In step S1013, the browser program 302, having acquired the search result list, performs the URL analysis on the search result list and acquires the URL analysis character string list 600.

In response to completing the processing in step S1013, in step S1014, the browser program 302 performs determination processing on the URL analysis character string list 600.

In step S1015, if the browser program 302 determines that the URL analysis character string list 600 contains no entry in the category field 601 or that each category in the category field 601 in the URL analysis character string list 600 has one element, the processing proceeds to step S1016.

In step S1016, the browser program 302 instructs the browser 301 to display a search result screen 220 illustrated in FIG. 2C, and the browser 301 displays the search result 221 in the center of the search result screen 220.

In step S1017, if the browser program 302 determines that each category in the category field 601 of the URL analysis character string list 600 has a plurality of elements, the browser program 302 performs the processing of steps S1018 to S1022.

In step S1018, the browser program 302 issues a hierarchical DB request to the server program 303.

In step S1019, the browser program 302 acquires the hierarchical DB 700 from the server program 303.

In step S1020, the browser program 302 generates an additional search word list by using the acquired hierarchical DB 700.

In response to completing the processing in step S1020, in step S1021, the browser program 302 returns the additional search word list 900 to the browser 301.

In step S1022, the browser program 302 returns the search result 221 to the browser 301.

After step S1022, the browser 301 displays the search result 211, the additional search word list 212, and the re-search button 213 on the search result screen 210. The additional search word list 212 enumerates elements 902 as a result of classifying the additional search word list 900 for each category 901.

If the number of elements (additional search words) 902 is 0 or 1 in step S1015, the browser program 302 provides the browser 301 with the search result 221 without providing the browser 301 with the additional search word list 212 as illustrated in FIG. 2C in step S1016.

If the number of elements (additional search words) 902 is 2 or more in step S1017, the browser program 302 provides the browser 301 with the search result 211 and the additional search word list 212 as illustrated in FIG. 2B in steps S1021 and S1022.

The present embodiment provides an effect of enabling the user to grasp the search word for re-search to narrow down the search result 211, as in the first embodiment. In addition, there is an effect that the additional search word list 212 is displayed by the browser 301 in a short processing time. If only one additional search word is obtained as a result of analyzing the search result URL list 212 and hence classification is not required, unlike the first embodiment, the browser 301 does not display the additional search word list 212 on the search result screen 220. This eliminates the need of communicating with the server program 303, thus improving the display speed of the search result screen 220. The additional search word list 212 that has not been classified is often information not needed for the user. Therefore, not displaying the additional search word list 212 on the search result screen 220 provides an effect of improving the user's visibility on the search result screen 220.

### Other Embodiments

Aspects of the present disclosure can also be achieved by supplying a recording medium storing program code for realizing the functions of the above-described embodiments to an information processing apparatus or a server, and causing the information processing apparatus or server (or CPU) to read and execute the program code stored in the recording medium. In this case, the program code itself, read from the recording medium, realizes the functions of the above-described embodiments, and the recording medium storing the program code constitutes the present disclosure.

Examples of storage media for supplying the program code include a flexible disk, hard disk, optical disk, magneto-optical (MO) disk, compact disc read only memory (CD-ROM), compact disc recordable (CD-R), magnetic tape, nonvolatile memory card, ROM, and digital versatile disc (DVD).

The functions of the above-described embodiments are also implemented in a case where an operating system (OS) operating on the computer executes part or whole of actual processing based on instructions of the program code.

The functions of the above-described embodiments are also implemented in a case where the program code read from the storage medium is written in a memory included in a function expansion board inserted into the computer or a function expansion unit connected to the computer, and a CPU included in the function expansion board or the function expansion unit executes part or whole of actual processing based on instructions of the program code.

The supply of the program code to the information processing apparatus can be implemented through the Internet and other communication methods such as a local area network (LAN) and a dedicated circuit.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-021453, filed Feb. 13, 2025, which is hereby incorporated by reference herein in its entirety.

What is claimed is:

1. A method for controlling an information processing apparatus, the method comprising:
receiving an input of a first word as a word to be used in a search;
performing, using the first word, search processing for searching for content in a web site provided by a predetermined server;
acquiring a result of the search processing;
classifying a plurality of pieces of content corresponding to the result of the search processing into a plurality of categories based on information included in a plurality of Uniform Resource Locators (URLs) included in the result of the search processing;
classifying the plurality of pieces of content corresponding to the result of the search processing into a plurality of elements each corresponding to a category of the plurality of categories based on the information included in the plurality of URLs;
receiving a selection of at least one element from the plurality of elements;
displaying at least one piece of content corresponding to a second word as at least one word corresponding to the at least one of the selected elements from among the plurality of pieces of content; and
performing search processing for searching for content in the web site by using the first word and the second word as at least one word corresponding to the at least one of the selected elements.

2. The method according to claim 1, wherein the content is a product manual of a printer.

3. The method according to claim 1, further comprising extracting a hierarchical character string from each of the plurality of URLs, wherein the plurality of pieces of content is classified into the plurality of categories and the plurality of elements based on the extracted hierarchical character string.

4. The method according to claim 1,
wherein content corresponding to a URL from which a first hierarchical character string is extracted is classified into a first category and a first element,
wherein content corresponding to a URL from which a second hierarchical character string is extracted is classified into the first category and a second element,
wherein content corresponding to a URL from which a third hierarchical character string is extracted is classified into a second category and a third element, and
wherein content corresponding to a URL from which a fourth hierarchical character string is extracted is classified into the second category and a fourth element.

5. The method according to claim 1, further comprising acquiring a predetermined database from a server different from the predetermined server, wherein the plurality of pieces of content is classified into the plurality of categories and the plurality of elements based on the information included in the plurality of URLs and the predetermined database.

6. An information processing apparatus, comprising:
an input interface configured to receive an input of a first word as a word to be used in a search; and
a memory storing a program that when executed causes the information processing apparatus to:
perform, using the first word, search processing for searching for content in a web site provided by a predetermined server;
acquire a result of the search processing;
classify a plurality of pieces of content corresponding to the result of the search processing into a plurality of categories based on information included in a plurality of Uniform Resource Locators (URLs) included in the result of the search processing;
classify the plurality of pieces of content corresponding to the result of the search processing into a plurality of elements each corresponding to a category of the plurality of categories based on the information included in the plurality of URLs;
receive a selection of at least one element from the plurality of elements;
display at least one piece of content corresponding to a second word as at least one word corresponding to the at least one of the selected elements from among the plurality of pieces of content; and
perform search processing for searching for content in the web site by using the first word and the second word as at least one word corresponding to the at least one of the selected elements.

7. A non-transitory computer-readable storage medium storing a program which, when executed, causes an information processing apparatus to:
receive an input of a first word as a word to be used in a search;
perform, using the first word, search processing for searching for content in a web site provided by a predetermined server;
acquire a result of the search processing;
classify a plurality of pieces of content corresponding to the result of the search processing into a plurality of categories based on information included in a plurality of Uniform Resource Locators (URLs) included in the result of the search processing;
classify the plurality of pieces of content corresponding to the result of the search processing into a plurality of elements each corresponding to a category of the plurality of categories based on the information included in the plurality of URLs;
receive a selection of at least one element from the plurality of elements;
display at least one piece of content corresponding to a second word as at least one word corresponding to the at least one of the selected elements from among the plurality of pieces of content; and
perform search processing for searching for content in the web site by using the first word and the second word as at least one word corresponding to the at least one of the selected elements.
